(19) United States
(12) Patent Application Publication
(10) Pub. No.: US 2026/0132281 A1
(43) Pub. Date: May 14, 2026

(54) PVC COMPOSITION FOR SLUSH MOLDING APPLICATIONS

(71) Applicants: Rohm and Haas Company, Collegeville, PA (US); Dow Global Technologies LLC, Midland, MI (US)

(72) Inventors: Hailan Guo, Warrington, PA (US); Agnes Verbois, Wissembourg (FR); Ian J. Drake, Conshohocken, PA (US); Johnpeter N. Ngunjiri, Gilbertsville, PA (US)

(21) Appl. No.: 19/119,144

(22) PCT Filed: Oct. 11, 2023
(86) PCT No.: PCT/US2023/034871

§ 371 Date: Apr. 8, 2025

(30) Foreign Application Priority Data
Oct. 12, 2022 (EP) 22201182.7

(51) Int. Cl. C08L 27/06; B29C 41/18; B29K 27/06; B29K 105/00; B32B 5/18; B32B 27/06; B32B 27/30; B32B 27/40; C08J 3/12; C08J 3/21

(52) U.S. Cl. CPC C08L 27/06; B32B 5/18; B32B 27/065; B32B 27/304; B32B 27/40; C08J 3/122; C08J 3/21; B29C 41/18; B29K 2027/06; B29K 2105/0064; B32B 2250/02; B32B 2250/24; B32B 2266/0278; C08J 2327/06; C08J 2433/04; C08L 2205/06

(57) ABSTRACT

A method of making a powder polyvinyl chloride-based composition comprises blending an emulsion of a polyvinyl chloride resin and a flexible acrylic resin to form a polyvinyl chloride resin/flexible acrylic resin blend. The polyvinyl chloride/flexible acrylic resin blend is isolated to form the powder polyvinyl chloride-based composition. A powder polyvinyl chloride-based composition, a polyvinyl chloride formulation, an article formed from the powder polyvinyl chloride-based composition, and a method for forming the article are also disclosed.

### FIELD

The present invention relates to a powder polyvinyl chloride (PVC)-based composition, to a process for making a powder polyvinyl chloride-based composition, and an article therefrom.

### BACKGROUND

Polyvinyl chloride (PVC) is a widely used material in a variety of market segments such as automobile; building and construction; medical and consumer care; and residential and commercial buildings. PVC is also extensively used in automotive interior for soft touch applications such as artificial leather or skins for structural elements, including, instrument panels, door panels, and the like. Slush molding of interior soft skins is one method that produces the best surface replication in multiple grains across a part. Slush molding is a preferred method of making interior soft skins for instrument and door panels and other interior trim parts. For example, complex shapes, grain mixes, geometric grains, deep profile lettering, and logos are needed for parts. Surfaces with exceptional tactile feel and adjustable gloss levels are achieved using slush molding. To improve the flexibility of PVC material for cold temperatures (for example, −30° C. ductility), plasticizers at concentrations of approximately (˜) 50 parts per hundred parts (phr) are used to provide subzero temperature ductility.

Heretofore, plasticizers have been extensively used in PVC materials to provide ductility. However, plasticizers are prone to migration over time; and thus, the plasticizers can become detrimental to the integrity of the PVC material. For example, plasticizer migration disadvantageously creates “fogging” and brittleness to the PVC material over time. Thus, the performance of PVC skins deteriorates over time. And, despite the use of “super” stabilisers in PVC materials, plasticizer migration remains a problem with the use of known plasticizers. Additionally, some plasticizers, including phthalates, pose additional problems relating to toxicity. Therefore, it would be desirable to reduce or minimize the amounts of plasticizers in PVC compositions.

In the automotive industry, as the PVC skin deteriorates over time, the deployment of air bags in automobiles becomes a problem at cold (subzero) temperatures. Embrittled PVC skins tend to crack and fragment at cold temperatures when the airbag is deployed. During cold temperature air bag deployment, fragmentation of the airbag door area creates air-borne debris that can cause personal injury to the passenger in the automobile. Providing air bags having skins made of PVC material that do not fragment during deployment is a critical requirement for installation of PVC airbags in both new as well as “end of life” vehicles.

A heat-aging test is commonly used by automobile manufacturers to predict and understand the performance of an aged instrument panel. For example, it has been found that plasticized PVC will sacrifice more than 35 percent (%) of its original physical properties when exposed to heat at temperatures above 110° C. for periods of 500 hours or longer. When plasticized PVC is exposed to this kind of heat, the plasticized PVC loses its physical properties and the plasticized PVC becomes brittle. The accelerated loss of plasticizer contributes to the embrittlement of an article made from the plasticized PVC. Thus, an airbag having a skin made of plasticized PVC, when it becomes brittle and deployed, can result in fragmentation of the PVC material, especially when an airbag made of plasticized PVC material is deployed at cold temperatures (for example, at a temperature of −30° C.). Therefore, there is a need in the automotive industry for technology that improves the heat aging performance of plasticized PVC and that enables maintaining a low temperature ductility of plasticized PVC over the lifetime of a vehicle that employs parts made of plasticized PVC.

U.S. Patent Application Publication No. 2021/0017372 discloses a PVC-based composition including a flexible acrylic resin (FAR). The PVC and FAR are admixed with a plasticizer to form a mixture for manufacturing an article therefrom.

Conventional slush molding compositions typically comprise a suspension PVC (S-PVC) resin, an emulsion PVC (E-PVC) resin for use as a flow aid, plasticizers, and additional components such as stabilizers, UV stabilizers, pigments, etc. The S-PVC and plasticizers are the main components of slush molding compositions. Due to the issues of plasticizers addressed above, it would be desirable to reduce or minimize the amount of plasticizers used in slush molding applications.

It has been discovered that a blend of PVC (including either S-PVC and E-PVC) and FAR powders cannot be processed under slush molding conditions, which rely on heat alone and provides zero shear. It is therefore desirable to develop a powder PVC composition that is capable of being slush molded and still enables maintaining a low temperature ductility of plasticized PVC.

### SUMMARY

One aspect of the present invention is directed to a method of making a powder polyvinyl chloride-based composition comprising:
a) blending an emulsion of a polyvinyl chloride resin and an emulsion of a flexible acrylic resin to form a polyvinyl chloride resin/flexible acrylic resin blend; and
b) isolating the polyvinyl chloride resin/flexible acrylic resin blend to form the powder polyvinyl chloride-based composition.

Another aspect of the present invention is directed to a powder polyvinyl chloride-based composition prepared according to the other aspects of the invention.

Yet another aspect of the present invention is directed to a composition comprising polyvinyl chloride powder and the powder polyvinyl chloride-based composition prepared according to other aspects of the invention.

Still yet another aspect of the present invention is directed to an article made from the powder polyvinyl chloride-based composition prepared according to other aspects of the invention.

Another aspect of the present invention is directed to a method of making an article from a powder polyvinyl chloride-based composition comprising the steps of:
I) preparing a powder polyvinyl chloride-based composition by:
   a) blending an emulsion of a polyvinyl chloride resin and an emulsion of a flexible acrylic resin to form a polyvinyl chloride resin/flexible acrylic resin blend; and
   b) isolating the polyvinyl chloride resin/flexible acrylic resin blend to form the powder polyvinyl chloride-based composition; and
II) forming an article from the powder polyvinyl chloride-based composition of step I).

### BRIEF DESCRIPTION OF THE DRAWINGS

FIG. 1 is a schematic diagram of a core-shell polymer material showing the various layers of the core-shell material of the present invention.

FIG. 2 shows AFM Tapping mode images of a formulation containing plasticized PVC without FAR.

FIG. 3 shows AFM Tapping mode images of a formulation containing plasticized PVC with FAR according to an embodiment of the present invention.

FIG. 4 shows AFM Tapping mode images of a formulation containing plasticized PVC with FAR according to an embodiment of the present invention.

FIG. 5 shows AFM Tapping mode images of a formulation containing plasticized PVC with FAR according to an embodiment of the present invention.

### DETAILED DESCRIPTION

### Definitions

“Ductility” or “ductile” as used herein with reference to a material, means that the material has flexibility and a sheet of the material can perform without breaking (at a given temperature). The cold flex test in Ford specification WSS-M4D985-A3 defines a material as flexible where a sheet sample (50×150 mm) can bend 180 degrees over a 20 mm diameter mandrel without cracking. Similarly, the dart impact testing, as defined in ISO 6603 or ASTM D376, defines ductility as the ability of dart to penetrate a film sample at a certain speed (e.g., 6.7 meters per second (m/s)) without initiating any cracks or fragmentation.

“Cold temperature impact performance”, as used herein with reference to a material, means the ability of the material to withstand a high force or shock applied to the material over a short period of time. Herein, cold temperature impact performance is the ability of the material to be ductile at subzero temperatures (e.g., a temperature of between 0° C. and −40° C.).

“Heat aging”, as used herein with reference to a material, means the ability of the material to retain properties after conditioning for long periods of time at high (greater than ambient) temperatures (e.g., 1,000 hours at 120° C.). Ford specification WSS-M4D985-A3 defines acceptable heat aging of a material as a loss in tensile strength of less than (<) 25% of the material's original value and a loss in elongation to break of less than 50% of the material's original value.

“Impact resistance”, as used herein with reference to a material, means the ability of the material to withstand a high force or shock applied to the material over a short period of time. Good impact resistance is the ability of a material to absorb energy and plastically deform without fracturing (also referred as “toughness”)

A “tailored polymer melt rheology”, as used herein with reference to a resin product, means that the resin product can be processed into a film/sheet, or injection molded into articles using conventional plastic melt processing equipment including, for example, film extrusion/calendering, injection molding, and thermal forming.

“Compatibility”, as used herein with reference to a polymer, means the ability of two polymers to mix at a homogeneous level for the resulting polymer blend to give a desired performance.

“Miscibility”, as used herein with reference to a polymer, means the ability of two polymers to form a very homogeneous polymer blend at the molecular level.

“Migration”, as used herein with reference to a plasticizer, means the movement of a plasticizer out of a part (e.g., a sheet, skin, or molded part) and the loss of the plasticizer to the environment or into a composite material (e.g., a PU foam material) adjoining the part. Migration is a function of temperature and time and increases with higher (e.g., greater than ambient) temperatures and longer times.

“Tensile strength”, as used herein with reference to a material, means the maximum stress that a material can withstand while being stretched or pulled (for example, according to the thin film tensile test procedure described in ASTM D882).

In one aspect of the present invention, the PVC-based composition of the present invention is prepared by a method comprising blending an emulsion of a PVC resin and an emulsion of a FAR resin to form a PVC/FAR blend. The PVC/FAR blend is then isolated to form a powder PVC-based composition.

Emulsion PVC (E-PVC) resins and suspension PVC (S-PVC) resins differ mainly in the particle size. E-PVC resins generally have a smaller particle size than S-PVC resins. In conventional rotomolding applications, including slush molding, E-PVC resins are primarily used as flow aids. The PVC resin used in the powder may include, for example, emulsion grades of PVC, designated by those in the industry with a “K” value of from K56 to K72. As known to those skilled in the art, a “K” value is a measure of PVC resin molecular weight based on measurements of PVC solution viscosity as described in ISO 1628-2 (1998). A higher K value indicates a higher PVC molecular weight. K56 to K72 PVC grades of PVC materials are commonly used, for example, for manufacturing film and sheet products for packaging applications; and for building and construction applications.

Generally, the amount of the PVC resin component in the powder PVC-based composition can be for example from 20 wt % to 90 wt %; such as, for example, from 30 wt % to 90 wt %, from 40 wt % to 80 wt %, or from 55 wt % to 60 wt %; based on the total weight of all components in the powder PVC-based composition.

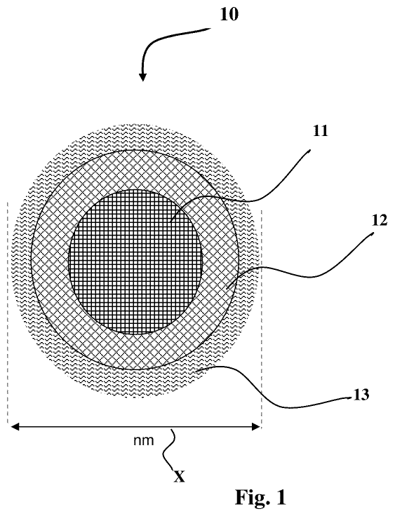

The FAR resin can be a core-shell polymer resin product which comprises at least one or more of the following layers: (i) a crosslinked core; (ii) an intermediate region layer; and (iii) an outermost layer. With reference to FIG. 1, there is shown a FAR core-shell polymer resin, generally indicated by numeral 10, including a crosslinked core 11, an intermediate layer 12, and an outer layer or shell 13. The overall size of the core-shell polymer resin product 10, as indicated by line X in FIG. 1, may be from 90 nanometers (nm) to 120 nm in, from 140 nm to 170 nm, or from 230 nm to 300 nm.

For example, the FAR resin may include a copolymer of methyl methacrylate (MMA) and butyl acrylate (BA) with crosslinked BA as the core 11; and a MMA-rich composition as the outermost layer or shell 13. In other examples, suitable FAR resin compounds may include, for example, FAR resin product grades available from The Dow Chemical Company such as products designated as 21308-XP, 21309-XP and 21520-XP, 21501-XP; and mixtures thereof.

In general, the concentration of the FAR resin useful in the PVC-based composition may range generally from 1 wt % to 60 wt %; from 5 wt % to 60 wt %; from 20 wt % to 45 wt %; or from 15 wt % to 35 wt %, based on the total weight of all components in the composition.

With reference to FIG. 1 again, there is shown the crosslinked core 11 which may comprise one or more materials. In one embodiment, the crosslinked core 11 may include greater than (>) 95 wt % of units derived, for example, from one or more monomers selected from alkyl (meth)acrylate monomers, and from 0.1 wt % to 5 wt % of units derived from a cross-linking monomer, a graft-linking monomer, or a combination thereof. The crosslinked core 11 can exhibit a glass transition temperature (T_{g}) of from −85° C. to −10° C. In one embodiment, the core 11 can be, for example, a crosslinked rubber. The crosslinked rubber beneficially provides impact resistance to an article made from the powder PVC-based composition.

The diameter of the core layer 11 may range, for example, from 90 nm to 100 nm, from 120 nm to 130 nm, or from 200 nm to 210 nm. However, the diameter of the core layer 11 may have other diameters depending on the desired purpose.

The intermediate region 12 may comprise one or more intermediate layers. For example, each of the intermediate layers used may include from 88.5 wt % to 100 wt % of units derived from one or more monomers selected from alkyl (meth)acrylate monomers and from 0 wt % to 5 wt % of units derived from (i) a cross-linking monomer, (ii) a graft-linking monomer, or (iii) a combination of two or more thereof. Optionally, the intermediate layer or layers may include from 0 wt % to 2.0 wt % units derived from one or more chain transfer agents such that a compositional gradient is provided between the intermediate layers. The compositional gradient of the intermediate layer(s) can transition between a lower T_{g} and an upper T_{g}, wherein the lower T_{g} can be at least −30° C. and the upper T_{g} can be up to 70° C. The intermediate layer(s) can beneficially provide a tailored polymer melt rheology useful for a melt process.

The outermost layer or shell 13 may comprise one or more materials. For example, the outermost layer or shell 13 may comprise, from 98.5 wt % to 100 wt % units derived from one or more monomers selected from alkyl (meth)acrylate, styrenic monomers, and combinations of two or more thereof. Optionally, the outermost layer 13 may include, for example, from 0 wt % to 1.5 wt % units derived from one or more chain transfer agents; and the outermost layer 13 may have, for example, a T_{g} of from 40° C. to 110° C. The optional functional groups incorporated into the outer layer 13 beneficially provide a compatibility effect between the core-shell polymer resin product with other polymeric substrates.

Optionally, the step of blending an emulsion of a PVC resin and an emulsion of a FAR resin may also include blending one or more heat stabilizers, one or more UV stabilizers, and/or one or more antioxidants to form the PVC/FAR blend. Alternatively, one or more of these components can be blended with additional PVC resin when a PVC formulation comprising the powder PVC-based composition is formed.

In a preferred embodiment, the process for making the powder PVC-based composition includes blending an emulsion of a PVC resin, an emulsion of a FAR resin, and optionally a heat stabilizer to form a PVC/FAR blend, and isolating the PVC/FAR blend to form a powder PVC-based composition. The blending can be performed by any known blending process.

The step of isolating the PVC/FAR blend preferably comprises spray drying or freeze drying the PVC/FAR blend to form a powder PVC-based composition.

In a preferred embodiment, the powder PVC-based composition may be used to manufacture automobile parts such that the parts have improved properties such as increased heat aging property and low temperature impact performance property after heat aging.

The powder PVC-based composition may be used as a masterbatch for preparing a PVC formulation for manufacturing articles. For example, the powder PVC-based composition may be mixed with additional powder PVC, such as a S-PVC resin, to prepare the PVC formulation for manufacturing articles. The PVC formulations are suitable for rotomolding processes, preferably slush molding processes.

The powder PVC-based compositions according to the present invention may enable a reduction in the amount of plasticizers used in PVC formulations compared to conventional PVC formulations using for rotomolding, and in particular for slush molding.

In another aspect of the present invention, PVC formulations can be prepared by blending the powder PVC-based composition with additional PVC resin and optionally a plasticizer and/or one or more additional components.

In the PVC formulations of the present invention, the additional PVC that is combined with the powder PVC-based composition can be any one or more rigid PVC resin; or can be a PVC material that already contains a plasticizer agent (i.e., a plasticized PVC material). For example, the plasticized PVC material may be pre-formulated with a plasticizing agent such that the total concentration of the plasticizing agent in the composition can be generally greater than 1 weight percent (wt %) and less than 80 wt % as described herein below with reference to the plasticizer. If the additional PVC added to the powder PVC-based composition is not a plasticized PVC, a plasticizer may be added to the formulation.

The PVC resin used in the PVC formulation may include for example a suspension grades of PVC, designated by those in the industry with a “K” value of from K56 to K72. As known to those skilled in the art, a “K” value is a measure of PVC resin molecular weight based on measurements of PVC solution viscosity as described in ISO 1628-2 (1998). A higher K value indicates a higher PVC molecular weight. K56 to K72 PVC grades of PVC materials are commonly used, for example, for manufacturing film and sheet products for packaging applications; and for building and construction applications. In addition to the S-PVC resin, the PVC resin may further comprise emulsion PVC (E-PVC) resin when preparing the PVC formulation.

Alternatively, the additional PVC used in the PVC formulation may comprise only E-PVC resin. In such embodiments, the PVC resin the PVC formulation may consist of or consist essentially of E-PVC resin. As used herein, the phrase consist essentially of E-PVC resin means the PVC resin in the PVC formulation comprises at least 95 wt % E-PVC relative to the total amount of PVC in the PVC formulation. Preferably, the additional PVC consists of or consists essentially of E-PVC.

A variety of one or more conventional plasticizer agents or compounds can be used in the PVC formulation. For example, the plasticizer can be one or more of phthalates such as diisononyl phthalate (DINP), diisodecyl phthalate (DIDP) and di-2-ethlehexyl phthalate (DEHP); a compound having the following chemical structure (I):

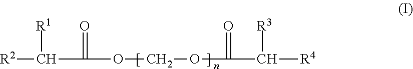

wherein R¹, R², R³, and R⁴ in structure (I) above, is each independently hydrogen or an organic group having 1 or more carbon atoms, and n is from 1 to 20; adipic acid esters such as diisononyl adipate (DINA) and diisodecyl adipate (DIDA) useful for cold temperatures; sebacic acid esters such as dibutyl sebacate (DBS) and di-2-ethylhexyl sebacate (DOS) useful for cold temperatures; phosphate softeners and polymeric softeners useful for low migration and resistance to extraction; trimellitates useful for resistance to high temperatures; and mixtures thereof. Preferably, the plasticizer comprises a sebacic acid ester or trimellitate.

The plasticizer may be added to the PVC formulation in a concentration of generally from 10 wt % to 60 wt %; from 20 wt % to 60 wt %; from 30 wt % to 50 wt %; or from 40 wt % to 50 wt % based on the total weight of all of the components in the PVC formulation.

Preferably, in the method of making the PVC formulation with the components described above, the concentration of the polyvinyl chloride resin in the PVC formulation can be from 20 wt % to 80 wt %; the concentration of the flexible acrylic resin in the PVC formulation can be from 1 wt % to 60 wt %; and the concentration of the plasticizer in the PVC formulation can be from 10 wt % to 60 wt %, wherein the concentrations are relative to the total weigh of all components in the PVC formulation.

A variety of other components can be added to the PVC-formulation during the blending step, including, for example, one or more of heat stabilizers, ultra violet light (UV) stabilizers, antioxidants, and mixtures thereof. Suitable heat stabilizers can be selected, for example, from one or more of metal-based salts and blends thereof such as alkaline earth metal salts (e.g., calcium or barium metal salts) in combination with cadmium or zinc salts (mixed-metal stabilizers); rare earth metal salts such as those based on lanthanum; basic and neutral lead salts; and mixtures thereof. The heat stabilizer can also be selected from one or more of metal-free, organic compounds (e.g., urea or thiourea); organotin compounds such as mercaptides, tin carboxylates, and octyl tin maleates; and mixtures thereof. Other heat stabilizers added to the PVC-based composition can include, for example, co-stabilizers such as epoxidized esters; melamine derivatives; and mixtures thereof. The heat stabilizer may be added to the PVC formulation in a concentration of generally from 0.01 wt % to 2 wt %, from 0.05 wt % to 1.5 wt %, or from 0.1 wt % to 1 wt %.

The UV stabilizer can be selected, for example, from one or more of UVA (ultraviolet light absorbers); HALS (hindered amine light stabilizer); and blends thereof; and mixtures thereof. The UV stabilizer may be added to the PVC-formulation in a concentration of generally from 0.01 wt % to 2 wt %, from 0.03 wt % to 1.5 wt %, or from 0.1 wt % to 1 wt %.

The antioxidant can be selected, for example, from one or more of phenolics; phosphites; thioesters; amines; and blends thereof; and mixtures thereof. The antioxidant may be added to the PVC formulation in a concentration of generally from 0.01 wt % to 2 wt %, from 0.03 wt % to 1.5 wt %, or from 0.1 wt % to 1 wt %.

Other optional compounds or additives that may be added to the PVC formulation may include, for example, release agents; antistatic agents; foaming agents; surfactants; catalysts; toughening agents; flow modifiers; adhesion promoters; diluents; other stabilizers; other plasticizers, catalyst de-activators; flame retardants; liquid nucleating agents; solid nucleating agents; Ostwald ripening retardation additives; and mixtures thereof. The concentration of the optional compounds or additives, when used in the powder PVC formulation, can be generally in the range of from 0 wt % to 20 wt % based on the total weight of the components in the PVC formulation. In one illustration, for example, the optional additives can be added to the PVC formulation at a concentration of from 0 wt % to 10 wt % when the PVC formulation is used for film and sheet applications.

Various methods may be used to fabricate articles or products comprising the PVC formulation. For example, the PVC formulations can be used in roto molding applications, such as, for example, slush molding. Other methods include injection molding, extrusion, and thermoformed/calendered applications. The PVC formulations can also be co-extruded, over-molded, or used in multilayer structures. Preferably, the PVC formulations are used in roto molding.

In general, an article or part can be made using the PVC formulation by first producing, for example, a sheet member substrate having a front surface side (also referred to herein as the skin side or A-side) and back side (also referred to herein as the B-side); and then, producing a foam (e.g., a polyurethane foam) on the B-side of the substrate with the skin side of the substrate remaining clear of other materials and open to the atmosphere. For example, the parts made with the sheet member substrates using the PVC formulation can be soft interior automotive skins which can be made by slush molding.

When the article made with the PVC formulation is a film or sheet member, the film or sheet may have a thickness in the range of from 0.2 millimeters (mm) to 2 mm, such as, for example, from 0.4 mm to 1.2 mm or from 0.5 mm to 1.0 mm.

The PVC article made in accordance with the above processes advantageously has several advantageous properties and benefits compared to conventional PVC articles. For example, in one embodiment, the PVC article of the present invention exhibits an improvement in heat aging. The heat aging performance property of the PVC article can be measured, for example, by ISO 188 or Ford Spec WSS-M4D985-A3 as defined and determined by the procedure described in ISO 37 (2017) for tensile properties. Generally, the heat aging can be carried out to a time of no more than 1,000 hours (hr) at 120° C., such as, for example, from 500 hr to 1,000 hr. In one preferred embodiment, the PVC article can exhibit a maximum change in tensile strength of no more than, or <25% and a loss of elongation at break of no more than, or <50%.

The PVC article preferably exhibits an improvement in low temperature impact performance after heat aging. The low temperature impact performance property of the PVC article can be measured, for example, by cold flexibility at −40° C. as defined and determined by the procedure described in Ford Spec WSS-M4D985-A3 (2010). Preferably, the PVC article should exhibit no cracks. Alternatively, a method which can be more quantitative and which may be used includes Multiaxial Impact Testing, as described in ISO 6603 or ASTM D3763 (2015), at 6.7 m/s at −30° C. Preferably, the PVC article should be 100% Ductile. The PVC article's ductility property is important especially when the PVC article is used for air bags installed in vehicles. The PVC is preferably completely ductile because any brittle failure of the PVC air bag provides a danger of broken pieces hitting a passenger during the air bag's deployment.

The powder PVC-based composition and the article made from the powder PVC-based composition in accordance with the present invention can be useful in a variety of applications including, for example, for slush molding used commonly for making soft interior automotive skins. In a preferred embodiment, the PVC-based composition may be used for making instrument panels and door panels. Methods useful for manufacturing soft skins are described, for example, in U.S. Pat. No. 8,674,027.

### EXAMPLES

The following examples are presented to further illustrate the present invention in detail but are not to be construed as limiting the scope of the claims. Unless otherwise stated all parts and percentages are by weight.

A masterbatch of a PVC-based composition according to the present invention was prepared according by adding the materials in Table 1 below sequentially at a specific temperature. PVC powder was added at room temperature to a Gunther Papenmeier/Welex blender, ramping the power to 15 A, adding TM 181 at 125° F., and adding the lubricant package at 150° F. The powder blends were allowed to cool down to room temperature, then Jayflex™ was added and the temperature was slowly increased to 125° F. The masterbatch had the composition according to Table 1. A powder PVC composition was also prepared.

TABLE 1

| | PVC | PVC/FAR |
|---|---|---|
| | Composition | Masterbatch |
| COMPONENT | (phr) | (phr) |
| PVC E1970 (K-70) | 100 | 100 |
| PVC | 0 | 50 |
| E1970/PARALOID ™ | | |
| 21520-XP (The Dow | | |
| Chemical Company) | | |
| (50:50) | | |
| TM-181 | 3 | 3 |
| Heat stabilizer (PMC | | |
| Group) | | |
| Jayflex ™ | 50 | 50 |
| Plasticizer (Exxon Mobil) | | |
| Paraplex ® G-62 | 3 | 3 |
| Lubricant (soybean oil | | |
| epoxide; Hallstar) | | |
| Total | 156 | 206 |

To simulate zero-shear slush molding conditions, a Carver hot press was preheated to 392° F. (200° C.). A small amount of the PVC masterbatch was placed into an alumina weighing pan, which was then placed on the Carver hot press platform. The platform was raised so the weighing pan touched the upper heating panel. The weighing pan was removed from the hot press after 5 min. The film was then peeled off of the weighing pan.

### Dispersion Morphology Analysis

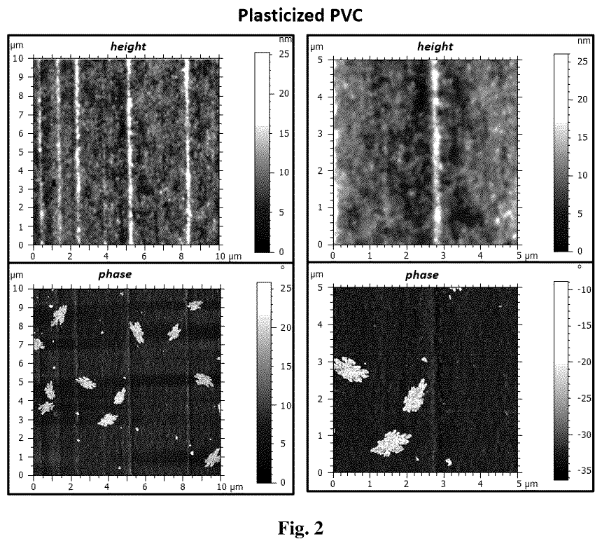

Block face samples were prepared to expose the bulk morphology of modified PVC. Cryo microtomy was applied to achieve flat faces for AFM analysis. FIG. 2 shows AFM Tapping mode images of plasticized PVC without FAR. Both height and phase images show homogenous PVC as expected. In the phase images, bright islands (crystal-like) of migrated plasticizer were observed. The vertical lines are knife marks produced during microtomy.

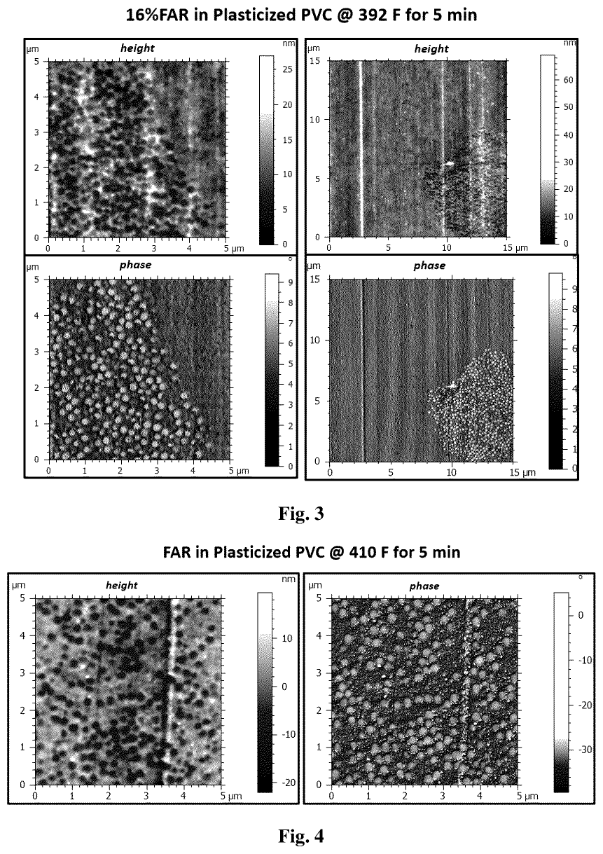

FIG. 3 shows AFM images of a blend of 100% neat E-PVC and a masterbatch powder of 50% FAR & plasticizer and 50% PVC according to the composition of Table 1. The total amount of FAR in the composition was 16 wt % based on the total weight of the composition. These samples were slush molded at 392° F. for 5 min. In these samples, regions of neat E-PVC were observed without any FAR particles. Notably, there is no migrated plasticizer as observed in FIG. 2. The plasticizer remained in the FAR particles. Islands of semi-aggregated FAR particles were observed sparsed within the PVC. A closer look at the aggregates showed that the particles were still separated in a continuous PVC matrix. This demonstrated that the masterbatch PVC is compatible with FAR in the presence of plasticizer. In the phase images, the FAR particles are bright contrast indicating higher stiffness compared to the PVC matrix.

FIG. 4 shows a 50/50 blend of PVC/FAR, according to the composition in Table 1, slush molded at 410° F. for 5 min. This sample preparation produced well dispersed particles across the PVC. At this processing temperature the particles were again in bright contrast with the PVC, indicating relatively higher stiffness than PVC.

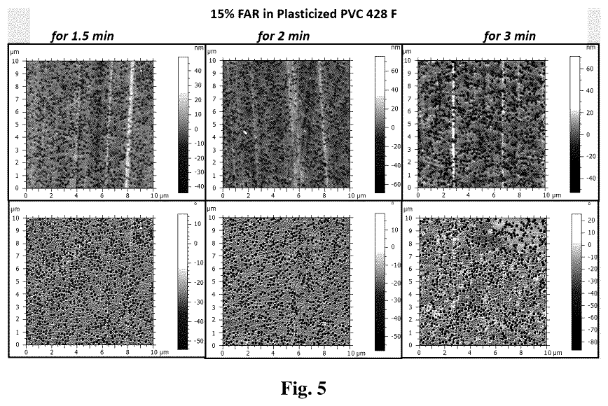

At a higher temperature of 428° F. (FIG. 5 below), FAR particles were again well dispersed irrespective of slush molding times (up to 5 min). This composition comprised a total of 15 wt % FAR based on the total weight of the composition. The FAR particles showed dark contrast compared to the PVC, indicating that they were softer than the PVC matrix. At a certain threshold (410° F.-428° F.) temperature, FAR particles softened relative to the PVC matrix. This is because the plasticizer migrated to the FAR particles from the PVC, making the PVC stiffer and, hence, better performance.

What is claimed is:

1. A method of making a powder polyvinyl chloride-based composition comprising:
a) blending an emulsion of a polyvinyl chloride resin and an emulsion of a flexible acrylic resin to form a polyvinyl chloride resin/flexible acrylic resin blend; and
b) isolating the polyvinyl chloride resin/flexible acrylic resin blend to form the powder polyvinyl chloride-based composition.

2. The method of claim 1, wherein step a) further comprises blending one or more heat stabilizers, one or more UV stabilizers, or one or more antioxidants with the emulsion of the polyvinyl chloride resin and the emulsion of the flexible acrylic resin.

3. The method of claim 1, wherein the polyvinyl chloride resin is present in an amount ranging from 20 wt % to 90 wt %, and the flexible acrylic resin is present in an amount ranging from 1 to 60 wt %, wherein the weight percentages are relative to the total weight of all components in the polyvinyl chloride-based composition.

4. The method of claim 1, wherein step b) comprises spray drying or freeze drying the polyvinyl chloride resin/flexible acrylic resin blend to form the powder polyvinyl chloride-based composition.

5. The powder polyvinyl chloride-based composition prepared by the method of claim 1.

6. A polyvinyl chloride formulation comprising powder polyvinyl chloride resin and the powder polyvinyl chloride-based composition of claim 5.

7. The polyvinyl chloride formulation according to claim 6, further comprising one or more plasticizer.

8. An article made from the polyvinyl chloride-based composition of claim 5.

9. The article of claim 8, wherein the article comprises a skin member.

10. The article of claim 9, wherein the skin member further comprises a polyurethane foam backing.

11. A method of making an article from a powder polyvinyl chloride-based composition comprising the steps of:
I) preparing a powder polyvinyl chloride-based composition by:
a) blending an emulsion of a polyvinyl chloride resin and an emulsion of a flexible acrylic resin to form a polyvinyl chloride resin/flexible acrylic resin blend; and
b) isolating the polyvinyl chloride resin/flexible acrylic resin blend to form the powder polyvinyl chloride-based composition; and
II) blending the powder polyvinyl chloride-based composition with additional powder polyvinyl chloride resin to form a polyvinyl chloride formulation; and
III) forming an article from the powder polyvinyl chloride formulation of step II).

12. The method of claim 11, wherein step II) further comprises blending the powder polyvinyl chloride-based composition and additional powder polyvinyl chloride resin with at least one plasticizer.

13. The method of claim 11, wherein forming the article from the powder polyvinyl chloride formulation of step II) comprises slush molding.
